(19) United States
(12) Patent Application Publication
(10) Pub. No.: US 2023/0231258 A1
(43) Pub. Date: Jul. 20, 2023

(54) NOVEL AEROGEL SANDWICH STRUCTURE AS THERMAL BARRIERS FOR HIGH VOLTAGE BATTERY THERMAL MITIGATION APPLICATIONS

(71) Applicant: Ford Global Technologies, LLC, Dearborn, MI (US)

(72) Inventors: Bhaskara Rao Boddakayala, Troy, MI (US); Deborah Frances Mielewski, Ann Arbor, MI (US); Haibo Zhao, Northville, MI (US); Alper Kiziltas, Sarikamis (TR)

(73) Assignee: Ford Global Technologies, LLC, Dearborn, MI (US)

(21) Appl. No.: 17/576,324

(22) Filed: Jan. 14, 2022

(51) Int. Cl. H01M 50/293

(52) U.S. Cl. CPC H01M 50/293

(57) ABSTRACT

A battery system includes a thermoresistant spacer disposed between a first battery module and a second battery module. The thermoresistant spacer includes a substrate of aluminum, an aluminum alloy, an inorganic paper, and graphene, and the substrate laminated with a heat insulating material and has a flame retardant disposed over the laminated substrate.

### FIELD

The present disclosure relates to battery systems with high temperature insulative properties, particularly for use in electric vehicles.

### BACKGROUND

The statements in this section merely provide background information related to the present disclosure and may not constitute prior art.

Referring to FIG. 1, a conventional battery system 20 includes a first battery module 22, a second battery module 24, a thermal interface material 34, a battery cold plate 36, and a conventional foam thermal barrier 26. Conventional foam thermal barriers are produced using highly flammable materials and provide comparatively low thermal insulation within battery systems. The low thermal insulation provided by conventional foam thermal barriers leads to possible flame spread in the event of ignition of the foam thermal barrier as well as increased heat propagation during thermal runaway within battery systems. This is because there is a tradeoff in selecting foam barriers, as during normal operation, battery modules expand and contract, so foam barriers should have adequate force deflection properties to allow the battery modules to expand and contract as necessary.

But battery modules, such as the first battery module 22 and the second battery module 24, can generate hot flammable vent gasses and experience high temperature events (i.e., thermal runaway, thermal propagation) during normal battery operation. During such high temperature events, heat can propagate from one battery module to neighboring battery modules (e.g., from the first battery module 22 to the second battery module 24). This heat propagation can lead to decreased performance of the battery system and fire.

The present disclosure addresses these concerns.

### SUMMARY

This section provides a general summary of the disclosure and is not a comprehensive disclosure of its full scope or all of its features.

In a form, a battery system includes a first battery module, a second battery module, and a thermoresistant spacer. The thermoresistant spacer includes a substrate covered with at least one of a thermoresistant additive and a flame retardant material. The thermoresistant spacer is disposed between the first battery module and the second battery module. The substrate includes at least one of aluminum, aluminum alloy, an inorganic paper, and graphene.

In variations of this battery system, which may be employed individually or in any combinations: a thickness of the substrate is greater than or equal to about 0.2 mm to less than or equal to about 1 mm; a ceramic coating is disposed over the substrate; the thermoresistant additive includes an aerogel layer disposed over the ceramic coating; a hydrophobic layer is disposed over the aerogel layer; a flame retardant is disposed over the hydrophobic layer; the flame retardant is formed of at least one of oxidized polyacrylonitrile cloth, basalt cloth, calcium silicate cloth, silicon, glass mat, aluminum oxide fiber cloth, and mixtures thereof; and the flame retardant is formed of oxidized polyacrylonitrile cloth.

In another form, a battery system includes a first battery module, a second battery module, and a thermoresistant spacer. The thermoresistant spacer includes a substrate disposed between the first battery module and the second battery module. The substrate may be at least one of aluminum, aluminum alloy, an inorganic paper, and graphene. An oxidized polyacrylonitrile cloth is disposed on at least an outer surface of the resistant spacer.

In variations of this battery system, which may be employed individually or in any combinations: at least a thermoresistant additive is disposed over the substrate, and, in some such variations, the thermoresistant additive includes an aerogel layer; the thickness of the oxidized polyacrylonitrile cloth is greater than or equal to about 0.3 mm to less than or equal to about 1 mm; and the thickness of the substrate is greater than about 0.2 mm to less than or equal to about 1 mm.

In a further form, a battery system includes a first battery module, a second battery module, and a thermoresistant spacer disposed between the first battery module and the second battery module. The thermoresistant spacer includes a substrate covered with a thermoresistant additive layer having a thickness of less than or equal to about 1 mm. A flame retardant material is disposed on at least an outer surface of the resistant spacer.

In variations of this battery system, which may be employed individually or in any combinations: the thermoresistant additive layer further includes at least one of glass bubbles, mica powder, kaolin powder, milled basalt fibers, and quartz fibers, and in some such variations, the thermoresistant additive layer includes aerogel; at least seven battery modules are spaced sequentially apart from one another to form a plurality of channels, and a thermoresistant spacer is disposed within each of the plurality of channels; a thickness of the flame retardant material is greater than or equal to about 0.3 mm to less than or equal to about 1 mm; the flame retardant material includes at least one of oxidized polyacrylonitrile cloth, basalt cloth, calcium silicate cloth, silicon, glass mat, and aluminum oxide fiber cloth; and the substrate includes at least one of aluminum, aluminum alloy, an inorganic paper, and graphene.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a conventional battery system;

FIG. 2 illustrates a battery system according to one form of the present disclosure;

FIG. 3 illustrates a thermoresistant spacer for the battery system according to FIG. 2;

FIG. 4 illustrates in block format a method of forming a thermoresistant spacer according to the present disclosure; and

FIG. 5 illustrates a battery system according to a further form of the present disclosure.

FIG. 5 illustrates in block format a method of forming a substrate for a thermoresistant spacer according to the present disclosure.

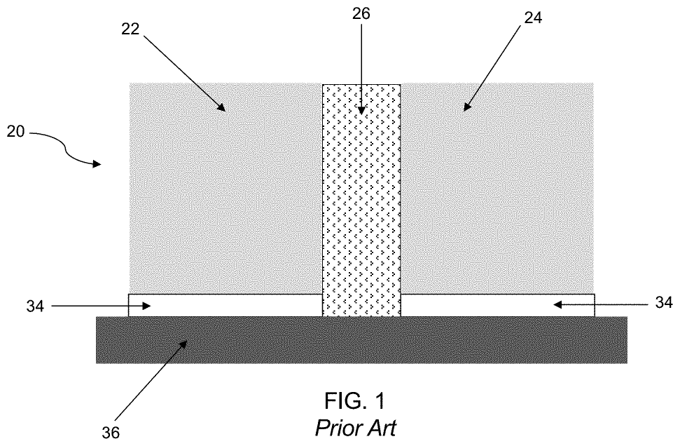

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

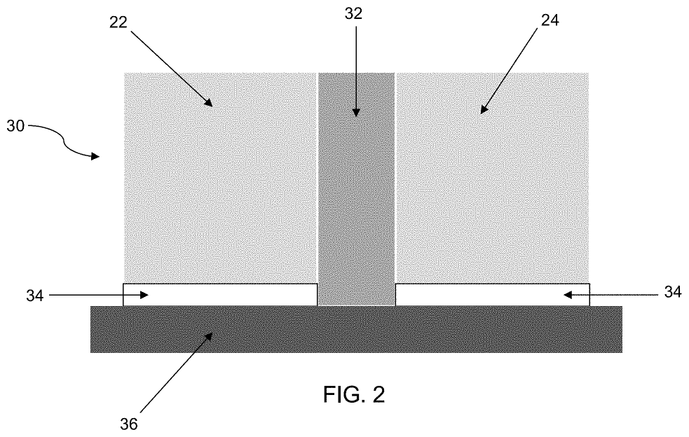

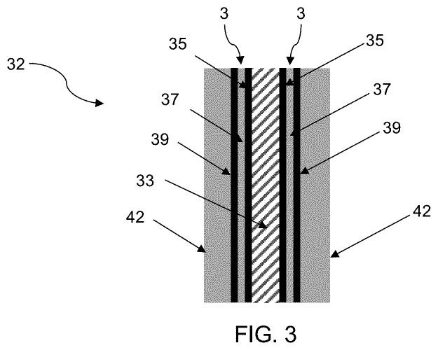

Referring to FIG. 2, a battery system 30 according to the present disclosure includes a first battery module 22, a second battery module 24, a thermoresistant spacer 32 comprising a substrate 33 (as shown in FIG. 3) laminated with a low-viscosity flame retardant adhesive and a flame retardant material with a flame retardant covering (e.g., cloth) disposed over the laminated substrate, a thermal interface material 34, and a battery cold plate 36. The substrate 33 is laminated with a low-viscosity flame retardant adhesive and a flame retardant material and has a flame retardant covering (e.g., cloth) disposed over the laminated substrate. The thermoresistant spacer 32 is disposed between the first battery module 22 and the second battery module 24, and the substrate 33 of the thermoresistant spacer 32 may be formed of an aluminum, an aluminum alloy, an inorganic paper, and graphene, as explained in greater detail below. In some aspects of the present disclosure, the thickness of the substrate 33 of the thermoresistant spacer 32 is greater than or equal to about 0.2 mm to less than or equal to about 1 mm, as described more fully below. The width and height of the substrate 33 depend on the configuration of the battery system 30.

In a variation, the substrate 33 includes aluminum or an aluminum alloy (e.g., aluminum 3003, among others). Where aluminum or aluminum alloy is contemplated, the thickness of the substrate 33 may be greater than or equal to about 0.2 mm to less than or equal to about 0.7 mm. As aluminum is electrically conductive, it may be desirable for the aluminum or aluminum alloy to be covered with a thin film of a resistor material, such as a ceramic. Aluminum desirably provides dissipation and acts as a heat sink during thermal runaway events.

In another variation, the substrate 33 includes graphene. Where graphene is contemplated, the thickness of the substrate 33 may be greater than or equal to about 0.4 mm to less than or equal to about 1 mm. Like aluminum, graphene is electrically conductive; accordingly, it may be desirable for the graphene to be covered with a thin film of a resistor material, such as a ceramic.

In a further variation, the substrate 33 includes an inorganic paper (e.g., paper made from inorganic hydroxyapatite, carboxymethyl, among others). Where inorganic paper is contemplated, the thickness of the substrate may be greater than or equal to about 0.5 mm to less than or equal to about 0.7 mm. Inorganic paper is not electrically conductive.

Referring now to FIG. 3, the substrate 33 is coated (e.g., laminated) with a heat resistant layer 3. The heat resistant layer 3 may include, by way of not-limiting example, a flame retardant adhesive compound (e.g., a low viscosity, flame retardant mixed two-part epoxy encapsulating compound) that is mixed with a high temperature resistant compound. In a variation, the flame retardant adhesive compound is a flame retardant epoxy, silicone with intumescent, among others. The high temperature resistant compound may be at greater than or equal to 1 wt. % to less than or equal to about 3 wt. % and may further be formed of aerogel particles having a diameter of less than 1 mm, by way of example. In a form, the high temperature resistant compound is at about 2 wt. %. Over the heat resistant layer 3, a flame retardant material (e.g., flame retardant material 42) may be disposed thereover. In a form, the flame retardant material has a thickness of about 1 mm. While it is shown in FIG. 3 that the flame retardant material 42 is disposed over both sides of the thermoresistant material, the flame retardant material 42 may be disposed on any portion of the outer surface of the thermoresistant spacer 32, which may take any appropriate shape or geometry. The flame retardant material 42 can tolerate temperatures up to 1,000° C. In an aspect, the heat resistant layer 3 further includes any of a ceramic coating 35, a heat resistant layer 37 (also referred to herein as an aerogel layer 37), or a hydrophobic layer 39 (each described more fully below) disposed over the substrate 33.

In one aspect, the thickness of the flame retardant material 42 is greater than or equal to about 0.3 mm to less than or equal to about 1 mm. In other aspects of the present disclosure, the flame retardant material 42 includes at least one of oxidized polyacrylonitrile cloth, basalt cloth, calcium silicate cloth, silicon, glass mat, and aluminum oxide fiber cloth. In one form of the present disclosure, the flame retardant material 42 is oxidized polyacrylonitrile cloth and may be, for example, a low oxygen index (e.g., about greater than or equal to about 35% to less than or 50%) oxidized polyacrylonitrile cloth.

Optionally, the ceramic coating 35 may be applied directly on the substrate 33. In operation, the ceramic coating 35 electrically isolates the substrate 33 from the battery system 50 and dissipates heat to the substrate 33 in instances where the substrate 33 includes aluminum, aluminum alloys, or graphene. Non-limiting examples of ceramics include alumina, alumina nitride, sapphire, among others.

Optionally, the aerogel layer 37 may be applied directly on the ceramic coating 35, or, if there is no ceramic coating 35, directly on the substrate 33. The aerogel layer 37 may be of an aerogel and include an adhesive (e.g., epoxies, polyvinyl ethers, among others), wherein the adhesive assists with adhering the aerogel layer 37 to the ceramic coating 35 or the substrate 33, as the case may be. The aerogel provides the substrate 33 with enhanced thermoresistant properties. The thickness of the aerogel layer is typically less than or equal to about 15 microns.

Optionally, the hydrophobic layer 39 may be applied directly on the aerogel layer 37, or, if there is no aerogel layer 37, on the ceramic coating 35, or if there is no aerogel layer 37 or ceramic coating 35, on the substrate 33. The thickness of the hydrophobic layer 39 may be greater than or equal to about 1 nm to less than or equal to about 15 microns. Non-limiting examples of hydrophobic layers include polytetrafluoroethylene, perfluoroalkoxy alkane, fluorinated ethylene propylene, among others.

The thermoresistant spacer 32 provides force deflection properties during normal charge and discharge operation of the battery system 30. More specifically, the thermoresistant spacer 32 compensates for expansion and contraction of the first and second battery modules 22, 24. In addition to force deflection properties, the thermoresistant spacer 32 provides a thermal barrier between the first and second battery modules 22, 24 to isolate high temperature events and reduce heat propagation between the first and second battery modules 22, 24. The thermoresistant spacer 32 is able to withstand high temperatures (e.g., ranging from greater than or equal to about 700° C. to less than or equal to about 1,000° C.) produced within the battery system 30 during a thermal runaway event and vent gasses out of a battery pack without combustion.

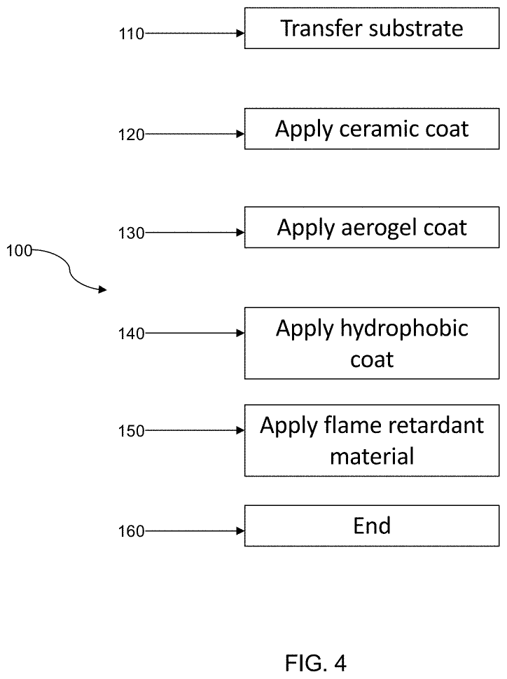

Referring to FIG. 4, a method 100 for forming a thermoresistant spacer (e.g., thermoresistant spacer 32) is provided. At step 110, a substrate (e.g., substrate 33) is transferred (e.g., along a conveyor, among others) to a ceramic coating station. At step 120, an optional ceramic coating (e.g., ceramic coating 35) is optionally applied over at least a portion of the substrate at the ceramic coating station. The optional ceramic coating may be applied by known methods, such as vapor deposition, spraying (e.g., thermal spraying), among others. Subsequently, at step 130, the substrate is transferred to an aerogel station, wherein an optional aerogel layer (e.g., aerogel layer 37) is optionally applied over at least a portion of the substrate at the aerogel station. The optional aerogel layer may be applied by known methods, such as vapor deposition, spraying (e.g., thermal spraying), among others. In another form, the optional aerogel layer is formed by applying an aerogel blanket over the substrate. In such a method, it is contemplated that a continuous process is used to spray a clear coat layer over a surface of an aerogel blanket (e.g., by spraying with a nozzle head about one foot over the aerogel blanket air sprays a clear coat to the surface of the aerogel blanket. It is also contemplated a symmetrical bottom nozzle can also simultaneously treat a bottom surface of the aerogel blanket while the aerogel blanket is transferred at a speed of about 0.5 m/s to about 5 m/s, depending on the nozzle size and pressure at which it operates). Such an aerogel blanket may subsequently be applied over the substrate. Subsequently, at step 140, the substrate is transferred to a hydrophobic applicator station, wherein an optional hydrophobic layer (e.g., hydrophobic layer 39) is optionally applied over at least a portion of the substrate at the hydrophobic applicator station. The optional hydrophobic layer may be applied by known methods, such as vapor deposition, spraying (e.g., thermal spraying), among others. After any desired ceramic coating, aerogel layer, and hydrophobic layer is (are) applied over the substrate, a flame retardant material (e.g., flame retardant material 42) may be applied over the substrate at step 150. The process subsequently ends at 160 after any desired ceramic coating, aerogel layer, hydrophobic layer, and flame retardant material are disposed over the substrate, thereby forming a thermoresistant spacer (e.g., thermoresistant spacer).

The battery modules (e.g., the first and second battery modules 22, 24) are exemplary electrified vehicle batteries. The battery modules may be high voltage battery cells outputting electrical power to operate a vehicle and/or other electrical loads of the vehicle. It is further contemplated the battery modules may be other types of energy storage/output devices to electrically power the vehicle.

The thermal interface material 34 allows for energy transfer among the components of the battery system 30 (e.g., the first and second battery modules 22, 24, the thermoresistant spacer 32, and the battery cold plate 36) by providing a pathway for heat to flow away from the batteries (e.g., the first and second battery modules 22, 24). Since the thermal interface material 34 is used near electrical components, such as batteries, the thermal interface material 34 desirably exhibits high dielectric strength. The battery cold plate 36 may be made of lightweight aluminum and stabilizes the battery cell temperature and provides a desired temperature uniformity. The battery cold plate 36 also may provide increased performance and lifespan of the battery.

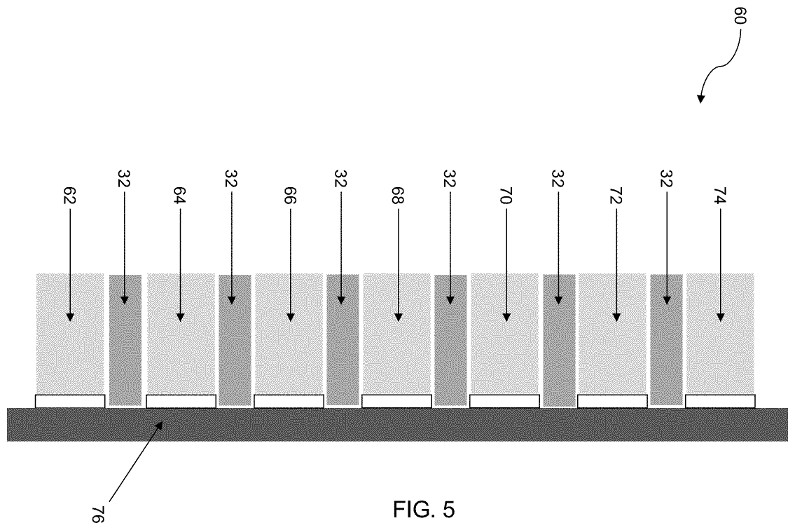

In another form of the present disclosure illustrated in FIG. 5, a battery system 50 includes at least seven battery modules 54, 56, 58, 60, 62, 64, 66 sequentially spaced apart from one another to form a plurality of channels. A plurality of thermoresistant spacers (e.g., thermoresistant spacer 32) is disposed within each of the plurality of channels. The battery system 50 further includes a battery cold plate 52 as described previously. As shown, the battery system 50 includes seven battery modules; however, the present disclosure is not limited thereto. In some aspects, the battery system 50 may include greater than or equal to two to less than or equal to seven battery modules. In other aspects, the battery system 50 may include greater than or equal to seven battery modules to less than or equal to 40 battery modules. In yet other aspects, the battery system 50 may include at least 40 battery modules.

The plurality of thermoresistant spacers is formed of a corresponding plurality of substrates (e.g., substrate 33). The plurality of substrates may all be aluminum, aluminum alloys, inorganic paper, or graphene, or may be any combination of aluminum, aluminum alloys, inorganic paper, or graphene to achieve the desired properties of the battery system 50. Further, the plurality of thermoresistant spacers may in some forms be laminated or coated with different combinations of the ceramic coating 35, the aerogel layer 37, and the hydrophobic layer 39 of the heat resistant layer 3 as dictated by requirements of the battery system (e.g., battery system 50). By way of example, one of the plurality of battery modules may have a heat resistant layer 3 including only an aerogel layer 37, while another of the plurality of battery modules may have a heat resistant layer 3 including each of a ceramic coating 35, an aerogel layer 37, and a hydrophobic 39. The aforementioned examples are exemplary, and the scope of the present disclosure contemplates each of a number of plurality of battery modules may each have similar heat resistant layer profiles, all of the number of plurality of battery modules each have disparate heat resistant layer profiles, or any other such combination. Further, the plurality of thermoresistant spacers may have different combinations in which the flame retardant material (e.g., flame retardant material 42) is disposed over the plurality of thermoresistant spacers.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery system comprising:
a first battery module;
a second battery module; and
a thermoresistant spacer comprised of a substrate covered with at least one of a thermoresistant additive and a flame retardant material and disposed between the first battery module and the second battery module, wherein the substrate comprises at least one of aluminum, an aluminum alloy, an inorganic paper, and graphene.

2. The battery system according to claim 1, wherein a thickness of the substrate is greater than or equal to about 0.2 mm to less than or equal to about 1 mm.

3. The battery system according to claim 1 further comprising a ceramic coating disposed over the substrate.

4. The battery system according to claim 3, wherein the thermoresistant additive includes an aerogel layer disposed over the ceramic coating.

5. The battery system according to claim 4 further comprising a hydrophobic layer disposed over the aerogel layer.

6. The battery system according to claim 5 further comprising a flame retardant disposed over the hydrophobic layer.

7. The battery system according to claim 6, wherein the flame retardant material comprises at least one of oxidized polyacrylonitrile cloth, basalt cloth, calcium silicate cloth, silicon, glass mat, aluminum oxide fiber cloth, and mixtures thereof.

8. The battery system according to claim 7, wherein the flame retardant material is oxidized polyacrylonitrile cloth.

9. A battery system comprising:
a first battery module;
a second battery module;
a thermoresistant spacer comprised of a substrate disposed between the first battery module and the second battery module, wherein the substrate comprises at least one of aluminum, an aluminum oxide, an inorganic paper, and graphene; and
an oxidized polyacrylonitrile cloth disposed on at least an outer surface of the thermoresistant spacer.

10. The battery system according to claim 9, wherein the thermoresistant spacer further comprises at least a thermoresistant additive disposed over the substrate.

11. The battery system according to claim 10, wherein the thermoresistant additive comprises an aerogel layer.

12. The battery system according to claim 9, wherein a thickness of the oxidized polyacrylonitrile cloth is greater than or equal to about 0.3 mm to less than or equal to about 1 mm.

13. The battery system according to claim 9, wherein a thickness of the substrate is greater than or equal to about 0.2 mm to less than or equal to about 1 mm.

14. A battery system comprising:
a first battery module;
a second battery module;
a thermoresistant spacer comprised of a substrate covered with a thermoresistant additive layer having a thickness of less than or equal to about 1 mm disposed between the first battery module and the second battery module; and
a flame retardant material is disposed on at least an outer surface of the thermoresistant spacer.

15. The battery system according to claim 14, wherein the thermoresistant additive layer further comprises at least one of glass bubbles, mica powder, kaolin powder, milled basalt fibers, and quartz fibers.

16. The battery system according to claim 15, wherein thermoresistant additive layer further comprises aerogel.

17. The battery system according to claim 14, further comprising at least seven battery modules spaced sequentially apart from one another to form a plurality of channels and a thermoresistant spacer is disposed within each of the plurality of channels.

18. The battery system according to claim 14, wherein a thickness of the flame retardant material is greater than or equal to about 0.3 mm and less than or equal to about 1 mm.

19. The battery system according to claim 14, wherein the flame retardant material comprises at least one of oxidized polyacrylonitrile cloth, basalt cloth, calcium silicate cloth, silicon, glass mat, and aluminum oxide fiber cloth.

20. The battery system according to claim 14, wherein the substrate comprises at least one of aluminum, an aluminum alloy, an inorganic paper, and graphene.
